(19) United States
(12) Patent Application Publication
(10) Pub. No.: US 2025/0322499 A1
(43) Pub. Date: Oct. 16, 2025

(54) ROLLING DIFFUSION MODELS FOR SEQUENCE GENERATION

(71) Applicant: GDM Holding LLC, Mountain View, CA (US)

(72) Inventors: Jonathan Heek, Hilversum (NL); Tim Salimans, Utrecht (NL); Emiel Hoogeboom, Amsterdam (NL); David Ruhe, Amsterdam (NL)

(21) Appl. No.: 19/175,918

(22) Filed: Apr. 10, 2025

Related U.S. Application Data
(60) Provisional application No. 63/632,314, filed on Apr. 10, 2024.

(51) Int. Cl. G06T 5/60; G06T 5/50; G06T 5/70

(52) U.S. Cl. CPC G06T 5/60; G06T 5/50; G06T 5/70; G06T 2207/10016; G06T 2207/20081; G06T 2207/20084

(57) ABSTRACT

Systems, methods, and computer program code for generating a sequence of frames of data, such as a sequence of video image frames of a video. Implementations of the techniques involve obtaining a sequence of frames in a rolling window, determining a local time for each frame, and updating the rolling window using a de-noising (diffusion model) neural network and based on the local times. Techniques for training the de-noising neural network are also described.

### CROSS-REFERENCE TO RELATED APPLICATION

This application claims priority to U.S. Provisional Application No. 63/632,314, filed on Apr. 10, 2025. The disclosure of the prior application is considered part of and is incorporated by reference in the disclosure of this application.

### BACKGROUND

This specification relates to processing data using machine learning models.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system and method, implemented as computer programs on one or more computers in one or more locations, for generating a sequence of frames of data, such as a sequence of video image frames of a video. A method of training a de-noising neural network for use in the system is also described.

In implementations the method involves obtaining a sequence of frames in a rolling window of frames. For each of a series of diffusion model time steps the method determines a local time for each frame. The method updates the rolling window by, for each frame, determining an updated version of the frame by processing the frame and the local time for the frame using a de-noising (diffusion model) neural network. The rolling window is then moved such that a second frame of the updated rolling window becomes the first frame of a next rolling window of frames.

In another aspect there is described a computer-implemented method of training a de-noising neural network to generate a sequence of frames of data. The method involves obtaining training sequences, each comprising a sequence of frames of data, e.g., a video sequence. A local time is determined for each frame of a training sequence from the diffusion model time, and a noisy version of the frame is sampled from a noise distribution that depends on the local time for the frame. The de-noising neural network is trained using an objective function that depends on a difference between the frame and an estimate of the frame from the de-noising neural network.

There is also described a system comprising one or more computers, and one or more storage devices communicatively coupled to the one or more computers. The storage devices store instructions that, when executed by the one or more computers, cause the one or more computers to perform the operations of the described methods.

There is further described one or more non-transitory computer storage media storing instructions that when executed by one or more computers perform the operations of the described methods.

The subject matter described in this specification can be implemented in particular embodiments so as to realize one or more of the following advantages.

Implementations of the described systems and methods can generate better, i.e., more accurate, predictions of sequences of frames of data than some other approaches based on diffusion models, particularly when the temporal dynamics are complex. For example, the techniques can generate better video sequences.

The described techniques are also capable of rolling out, i.e., generating, a sequence for a variable number of time steps. Some other techniques cannot do this; or cannot do this without computing an entire sequence when adding each successive frame, which is computationally expensive; or cannot do this as accurately or efficiently.

Implementations of the described techniques use a rolling window-based approach that is adapted to predicting lower frequencies for frames that are more distant in the future, and to predicting higher frequency detail for frames that are closer in time to those most recently generated. In implementations no previously generated frame is specially privileged by the sequence generation process. These characteristics can help when generating sequences with complex dynamics. In implementations of the techniques the diffusion process progressively corrupts through time by assigning more noise to frames that appear later in a sequence, reflecting greater uncertainty about the future as the generation process unfolds.

The described techniques are much more memory and compute efficient than techniques that treat the video as a 3D tensor with the temporal axis as an extra spatial dimension, particularly when long sequences have to be predicted.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example system for generating a sequence of frames of data.

FIG. 2 is a flow diagram of an example process for generating a sequence of frames of data.

FIG. 3 illustrates a local time re-parameterization used in implementations of the techniques.

FIG. 4 illustrates operation of the described techniques.

FIG. 5 is a flow diagram of an example process for training a de-noising neural network.

FIG. 6 shows a Kolmogorov flow simulated using the described techniques.

Like reference numbers and designations in the various drawings indicate like elements.

### DETAILED DESCRIPTION

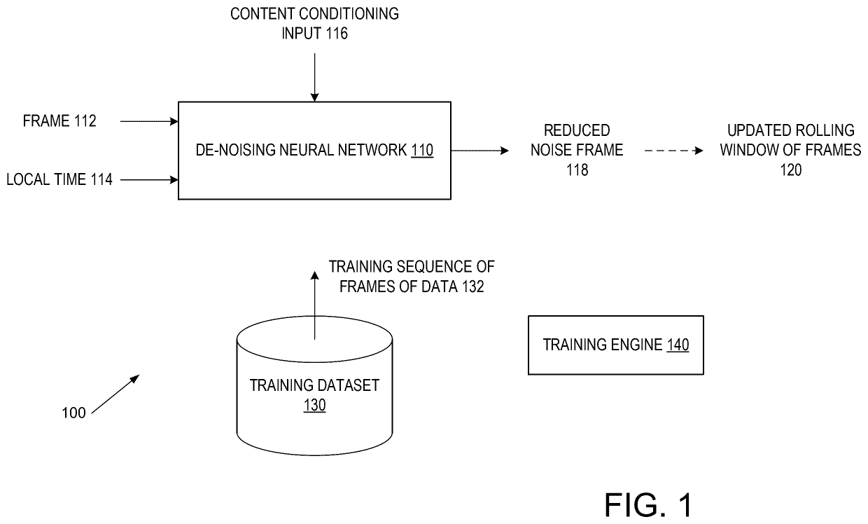

FIG. 1 shows a system 100 for generating a sequence of frames of data by successively generating frames in the sequence. In some implementations the frames of data are image frames of a video sequence. The system of FIG. 1 can be implemented as computer programs on one or more computers in one or more locations.

The system 100 comprises a de-noising neural network 110, that implements a diffusion model. The de-noising neural network 110 is configured to process a frame of data, e.g., an image frame 112, and a local time for the frame 114, to generate an updated, reduced noise version of the frame 118. In some implementations the de-noising neural network 110 is also configured to process a content conditioning input 116, i.e., the reduced noise version of the frame 118 is generated conditioned on the content conditioning input 116. Reduced noise frames are generated for a rolling window of frames, to obtain an updated rolling window 120, as described further below.

During training the system 100 also includes a training dataset 130 storing training sequences of frames of data 132; and a training engine 140 for training the de-noising neural network 110 as described later.

In general a frame of data comprises a plurality of data elements. The data elements may comprise pixels of an image, elements defining an audio waveform, or any other type of data.

The de-noising neural network 110 can have any suitable architecture consistent with processing values of the elements of a frame data as an input (e.g., pixel values) to generate a set of output values for a frame of data, i.e., to generate a set of corresponding output values. As some examples the de-noising neural network 110 can have a U-Net architecture or a variant thereof, or a Transformer neural network architecture (characterized by having a succession of attention layers) or a variant thereof, or a combination of these. As a particular example, the de-noising neural network 110 can have a U-ViT architecture (Bao, et al., “All are Worth Words: A ViT Backbone for Diffusion Models”, arXiv: 2209.12152, 2023). In general, however, the de-noising neural network 110 may comprise one or more feedforward, convolutional, attention, normalization, or other neural network layers.

Conditioning on the local time for the frame 114, and on the content conditioning input 116 (where present) may be performed in any convenient manner.

Processing a time generally involves processing data specifying the time, e.g., an embedding of the time. As one example, to condition on the local time for a frame the local time can be encoded as an embedding, such as a sinusoidal positional embedding, and added to or otherwise combined with each processed data element. As another example, the local time for the frame can be provided as side information to one or more layers of the de-noising neural network 110.

The de-noising neural network 110 can be conditioned on the content conditioning input 116 by, as an example, incorporating one or more cross-attention layers to attend to the conditioning data; or in any other convenient manner. The content conditioning input can be provided, e.g., as tokens or as an embedding representing the content conditioning input. For example the content conditioning input may be encoded into a sequence of embeddings using a text, image, audio, or multimodal Transformer model, such as a language model or vision language model.

In general the content conditioning input characterizes a content of the generated sequence of frames of data, e.g., defining one or more properties of the generated sequence of frames of data. For example, when the frames are image frames of a video sequence the content conditioning input may comprise text in a natural or computer language, or features of text, or audio, e.g., speech, or features of audio, that the video sequence should represent.

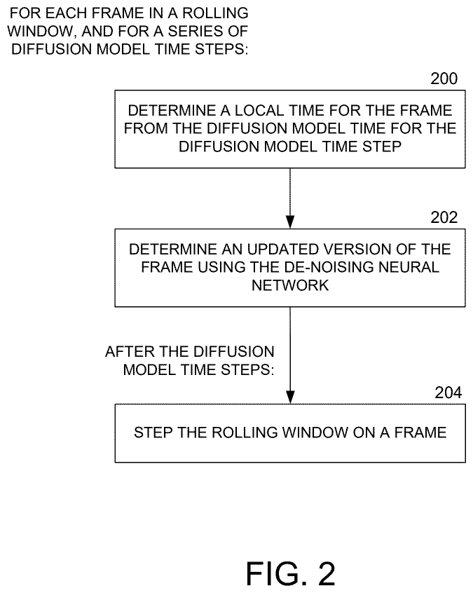

FIG. 2 is a flow diagram of an example process for obtaining a generated sequence of frames of data by successively generating frames in the sequence. The process of FIG. 2 may be implemented by one or more computers in one or more locations; for convenience the process is described with reference to the system of FIG. 1.

The process involves obtaining a sequence of frames in a rolling window of frames. The sequence of frames comprises the frames in the rolling window except for a final frame. In some implementations the sequence of frames can comprise all the frames in the rolling window except for the final frame; in others, frames may be skipped. A final frame for the rolling window can be determined by sampling the final frame from a noise distribution. In general, each successive frame in the rolling window has a greater level of noise than a preceding frame in the rolling window. References herein to sampling or processing a frame are to sampling or processing values of the frame, e.g., to sampling or processing pixel values of an image frame.

The process is performed for each of a series of T diffusion model time steps from an initial time step to a final time step. The initial time step and the final time step each correspond to a respective diffusion model time (t) in a diffusion model time range between an initial diffusion model time, e.g., t=1, and a final diffusion model time, e.g., t=0. For example, the initial time step may correspond to the initial diffusion model time, e.g., t=1. However, in implementations the final time step does not correspond to the final diffusion model time, e.g., it may be at t=1/T rather than at t=0.

The process involves determining the local time 114 for each frame from the diffusion model time corresponding to the diffusion model time step (step 200).

The local time for a frame varies between an initial local time for the initial time step (which corresponds to the diffusion model time for the initial time step), and a final local time for the final time step (which corresponds to the diffusion model time for the final time step). That is, the diffusion model time maps to a local time for each frame, e.g.,

$${t}_{win} , {t}_{w}^{lin} or {t}_{w}^{lin} ( {n}_{cln} ) ,$$

as described further later.

In implementations the final local time for a frame, e.g., t_{win}(t=0), corresponds to, i.e., matches, the initial local time for a preceding frame t_{win}(t=1) in the sequence. Thus, for each frame boundary within the window the local time is consistent across the fame boundary as the rolling window steps on a frame.

The process obtains the updated rolling window of frames 120 by, for each frame in the rolling window and for each diffusion model time step, determining an updated version of the frame (step 202). In general, determining the updated version of the frame comprises processing the frame 112 and the local time 114 for the frame using the (trained) de-noising neural network 110 to determine the reduced noise version of the frame 118.

After the series of diffusion model time steps, a first frame of the updated rolling window (which has been completely de-noised) is used as a next generated frame of data of the generated sequence of frames of data. The rolling window is moved such that a second frame of the updated rolling window becomes the first frame of a next rolling window of frames, i.e., the rolling window is stepped on a frame (step 206).

In some implementations the frame 112, the local time 114 for the frame, and the content conditioning input 116 are processed using the de-noising neural network 110 to determine the reduced noise version of the frame 118.

In some implementations the local time 114 for each frame is determined such that the final local time for a frame corresponds to the initial local time for a preceding frame in the sequence, for each frame of the rolling window and also for one or more frames preceding the rolling window, e.g., as

$${t}_{w}^{lin} ( {n}_{cln} ) ,$$

where n_{cin} defines the number of frames preceding the rolling window. The de-noising neural network 110 can process the frame 112, the local time 114 for the frame, and a sequence conditioning input, where the sequence conditioning input comprises one or more (n_{cln}) previously generated or “clean” frames of data.

The local time 114 can be determined as a monotonic function of (w+t−n_{cln})/(W−n_{cln}) where w indexes the frame in the rolling window starting from w=0 for the first frame of the rolling window, W is a total number of frames in the rolling window, and n_{cln} is an integer equal to or greater than zero.

In some implementations, determining the updated version of the frame involves processing the frame 112 and the local time 114 for the frame using the de-noising neural network 110 to generate a prediction of a de-noised version of the frame, e.g., of pixel values of a de-noised version of an image frame. The prediction of the de-noised version of the frame can then be used to determine the reduced noise version of the frame. For example, it may be combined with the (noisier) frame in a weighted combination.

In some implementations determining the updated version of the frame involves processing the frame 112 and the local time 114 for the frame using the de-noising neural network 110 to generate a noise prediction comprising a prediction of noise in the frame, e.g., of noise pixel values representing noise in a noisy image frame. The noise prediction can then be used to determine the reduced noise version of the frame, e.g., by subtracting the noise from the (noisier) frame. For example, a weighted version of the noise may be subtracted from the frame.

In some implementations determining the updated version of the frame 118 involves processing the frame 112 and the local time 114 for the frame using the de-noising neural network 110 to generate a score prediction for the frame, e.g., a score prediction for each pixel of an image frame. The score for a frame can define how the frame should be changed, e.g., how each pixel of an image frame should be changed, to reduce a level of noise in the frame. The score prediction can then be used to determine the reduced noise version of the frame.

In some implementations determining the reduced noise version of the frame 118 can involve sampling from a distribution p_{θ}(z_{t-1/T}|zₜ) where t is the diffusion model time that is mapped to a local time for the frame. Here p_{θ}(zₛ|zₜ) refers to a diffusion model, e.g., implemented as the de-noising neural network 110, with parameters, e.g., weights, θ, that processes a frame zₜ (at a time t) to generate an output that defines a reduced noise frame zₛ (at a time s). The de-noising neural network 110 can also be denoted f_{θ}(zₜ, t), where p_{θ}(zₛ|zₜ)=f_{θ}(zₜ, t).

The distribution p_{θ}(z_{t-t/T}|zₜ) can be a Gaussian distribution with a (multivariate) mean value determined by an output of the de-noising neural network 110, in general an output with the same dimensions as the input frame. Such a Gaussian distribution can have a non-zero variance, e.g., determined by an SNR schedule of the de-noising process, or a zero variance (i.e., the reduced noise version of the frame can be obtained deterministically rather than by sampling, e.g., in a strided implementation).

Any type of diffusion model can be used to determine the distribution p_{θ}(z_{t-1/T}|zₜ). For example, the distribution p_{θ}(z_{t-1/T}|zₜ) can be determined according to

$${p}_{θ} ( {z}_{s} \vert {z}_{t} ) = 𝒩 ( {z}_{s} \vert {μ}_{θ} ( {z}_{t} \vert s , t ) , {( \frac{{σ}_{t \vert s} {σ}_{s}}{{σ}_{t}} )}^{2} I )$$

where [symbol] (·) denotes a Gaussian distribution, I is the identity matrix, and

$${σ}_{t \vert s} = {σ}_{t}^{2} - {α}_{t \vert s}^{2} {σ}_{s}^{2}$$

where α_{t/s}=αₜ/αₛ. Here αₜ and σₜ are any positive scalar functions of t, and define a signal-to-noise ratio

$$S N R ( t ) = {α}_{t}^{2} / {σ}_{t}^{2}$$

that is monotonically decreasing in t (t∈[0,1]). The signal-to-noise ratio defines a noise schedule, i.e., a variation of a noise level with time in a series of successively de-noised frames. Any noise schedule can be used, e.g., a cosine-based noise schedule. In some implementations, but not necessarily, a variance preserving process is used in which

$${α}_{t}^{2} + {σ}_{t}^{2} = 1 .$$

In some implementations the de-noising neural network 110 predicts an estimate of a de-noised version of a frame from zₜ as \hat{x}_{θ}(zₜ, t); in some implementations it predicts an estimate of the noise used to generate xₜ as \hat{ϵ}_{θ}(zₜ, t); in some implementations it predicts a score (a gradient of log probability) as s_{θ}(zₜ, t). For example:

$${μ}_{θ} ( {z}_{t} \vert s , t ) = \frac{{σ}_{t \vert s} {σ}_{s}^{2}}{{σ}_{t}^{2}} {z}_{t} + \frac{{σ}_{t \vert s}^{2} {α}_{s}}{{σ}_{t}^{2}} {\hat{x}}_{θ} ( {z}_{t} , t )$$

$$or$$

$${μ}_{θ} ( {z}_{t} \vert s , t ) = \frac{1}{{α}_{t \vert s}} {z}_{t} - \frac{{σ}_{t \vert s}^{2}}{{α}_{t \vert s} {σ}_{t}} {\hat{ϵ}}_{θ} ( {z}_{t} , t )$$

$$or$$

$${μ}_{θ} ( {z}_{t} \vert s , t ) = \frac{1}{{α}_{t \vert s}} {z}_{t} + \frac{{σ}_{t \vert s}^{2}}{{α}_{t \vert {s}_{t}}} {s}_{θ} ( {z}_{t} , t )$$

An initial rolling window of frames can be determined by sampling each frame in the initial rolling window of frames from a noise distribution. Then, for each of a series of diffusion model time steps, the process can involve determining a local time for each frame in the initial rolling window of frames from the diffusion model time corresponding to the diffusion model time step.

The initial rolling window of frames can be obtained by, for each frame in the initial rolling window of frames and for each diffusion model time step, determining an updated version of the frame by processing the frame and the local time for the frame using the de-noising neural network, to determine a reduced noise version of the frame.

A particular example that combines some of the features described above is now described.

Consider a series of K frames in a rolling window, each of dimensionality D, denoted by x∈ [symbol] , and a global time t∈[0,1]) that is re-parameterized to a local, frame-dependent time tₖ, where k=0, . . . , K−1. Thus, each frame effectively has a different noise schedule. In implementations the local time of a frame is smaller than the local time of the next frame, i.e., tₖ≤tₖ₊₁ (so that more noise is added to future frames), but this is not essential. The rolling window has W<K frames, indexed by w=0, . . . , W−1.

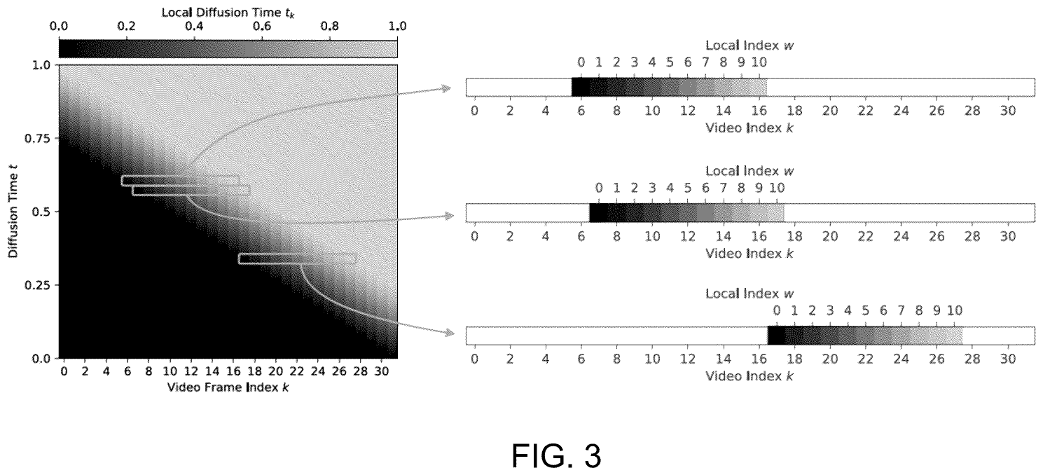

FIG. 3 illustrates such a re-parameterization, with global time t on the y-axis, frame index k on the x-axis, and local time tₖ indicated by shading. The local time is used to determine parameters σₜ_{ₖ} and αₜ_{ₖ} according to the noise schedule; as illustrated, the same noise schedule is applied to each rolling window of frames. The de-noising process can focus on the frames that are in the rolling window. The model can be, but need not be, conditioned on one or more (n_{cln}) previously generated and de-noised “clean” frames immediately before the rolling window. Where the model is conditioned on clean frames n_{cln}≥1; if there is no conditioning on clean frames n_{cln}=0. Sampling from the model using the de-noising neural network 110 amounts to traversing the image of FIG. 3 from top left to bottom right.

In implementations the local time 114 for a frame t_{win} runs from t=1 to t=0. The local time can be determined as t_{win}=g(w+t)/W) where g(·) is a monotonically increasing function of t with an output in the range [0,1]. This ensures that the final local time for one frame matches the initial local time for a preceding frame. As a particular example,

$${t}_{win} = {t}_{w}^{lin} = ( w + t ) / W , and {t}_{w}^{lin}$$

is in the range [w/W, (w+1)/W]. Thus local times run from

$$\frac{1}{W} , \frac{2}{W} , … , \frac{W}{W}$$

for each of the W frames, to

$$\frac{0}{W} , \frac{1}{W} , … , \frac{( W - 1 )}{W}$$

for the respective trames. In this way the local times remain invariant as the window moves from top left to bottom right in FIG. 2. Where one or more clean conditioning frames are included the local time 114 can be defined as

$${t}_{w}^{lin} ( {n}_{cln} ) = clip ( \frac{( w + t - {n}_{cln} )}{W - {n}_{cln}} )$$

where clip(·) clips to [0,1]. Given a value of t_{w}

$$( e . g . , {t}_{win} or {t}_{w}^{lin} )$$

values αₜ_{_{w}} and σₜ_{_{w}} can be determined from the noise schedule.

A particular example algorithm for generating a sequence of frames of image data in this way is given below:

```
Require: p_{θ}, n_{cln}, z₀ with local diffusion times
(0/W, . . . , (W − 1)/W) (i.e., progressively noised).
$Video Prediction \hat{x} ← \{ {z}_{0}^{{n}_{cln}} \}$
repeat
  Sample z^{W}~ [symbol]  (0, I)
  ${z}_{1} ← \{ {z}_{0}^{1} , … , {z}_{0}^{W - 1} , {z}^{W} \}$
  for t = 1, (T − 1)/T, . . . , 1/T do
    $Compute local times {t}_{w}^{lin} ( {n}_{cln} ) , w = 0 , … , W - 1$
    Sample zₜ₋₁/T~p_{θ} (zₜ₋₁|zₜ)
  end for
  $\hat{x} ← \hat{x} ⋃ \{ {z}_{0}^{{n}_{cln}} \}$
until Completed
```

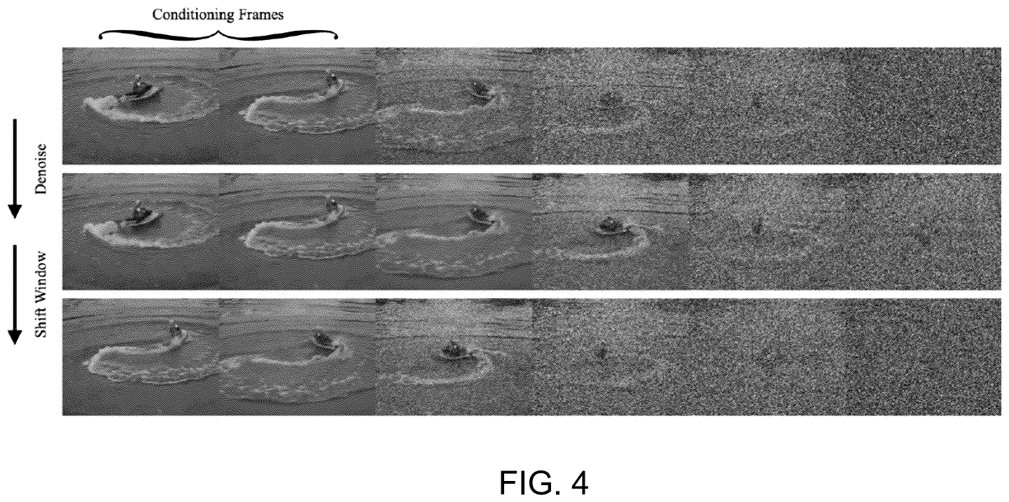

FIG. 4 illustrates the above described process for generating a sequence of frames of image data. In the illustration the input to the model comprises two clean conditioning frames and a sequence of partially denoised frames. The model denoises the frames by a small amount, and after denoising the sliding window shifts, and the fully denoised frames are concatenated with the clean conditioning frames. This process repeats until a desired number of frames is generated.

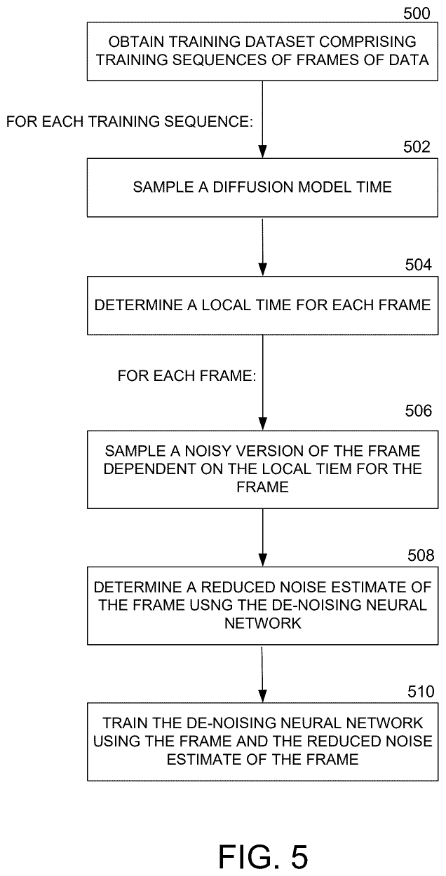

FIG. 5 is a flow diagram of an example process for training a de-noising neural network to generate a sequence of frames of data. The process of FIG. 5 may be implemented by one or more computers in one or more locations, e.g., to train the de-noising neural network 110.

At step 500 the process obtains a training dataset comprising training sequences, each training sequence comprising a sequence of frames of data such as a video sequence. The training process is performed for each of a plurality of the training sequences.

A diffusion model time is sampled from a distribution of diffusion model times (step 502), and a local time for each frame of the training sequence is determined from the diffusion model time (step 504). As previously described, the local time for a frame generally lies in a range between an initial local time corresponding to an initial diffusion model time, e.g., t=1, and a final local time corresponding to a final diffusion model time, e.g., t=0.

For each frame of the training sequence the method samples a noisy version of the frame from a noise distribution dependent on the frame and on the local time for the frame (step 506). The noisy version of the frame and the local time for the frame are processed using the de-noising neural network to determine an estimate of the frame, more particularly a reduced noise estimate (step 508). Optionally the de-noising neural network can also be conditioned on a content conditioning input that characterizes a content of the training sequence, such as the content conditioning input 116.

The de-noising neural network is trained using an objective function, in particular a loss function, that depends on a difference between the frame and the estimate of the frame (step 510). For example, the objective function can depend on ∥x−f_{θ}(zₜ, t)∥, with variables as defined previously. The loss can depend on a Euclidean (L2) or a squared Euclidean distance between the frame and the estimate of the frame; or some other metric can be used.

In general training the de-noising neural network involves backpropagating gradients of the objective function to update learnable parameters, e.g., weights, of the de-noising neural network 110 using any appropriate gradient descent optimization algorithm, e.g., Adam or another optimization algorithm.

In a similar way to that previously described, processing the noisy version of the frame and the local time for the frame, using the de-noising neural network 110, to determine the estimate of the frame can be done in a number of ways. As one example it can involve processing the frame and the local time for the frame using the de-noising neural network 110 to generate a prediction of a de-noised version of the frame, and using the prediction of the de-noised version of the frame to determine the estimate of the frame. As another example it can involve processing the frame and the local time for the frame using the de-noising neural network 110 to generate a noise prediction comprising a prediction of noise in the frame, and using the noise prediction to determine the estimate of the frame, e.g., by subtracting the noise prediction. As another example it can involve processing the frame and the local time for the frame using the de-noising neural network 110 to generate a score prediction for the frame, and using the score prediction to determine the estimate of the frame.

Referring again to FIG. 3, a window that is placed at the very left edge of the illustrated region can have a frame that is not fully noised at its right hand edge, in which case the SNR may never be minimal. Optionally a correction can be made for this. More particularly determining the local time for each frame of the training sequence can involve selecting between a first local time schedule and a second local time schedule. The first local time schedule is configured for training the de-noising neural network to initialize a sequence of generated video frames such that each successive frame has a greater level of noise than a preceding frame. The second local time schedule is configured for training the de-noising neural network to determine a reduced noise version of each frame in a sequence of frames in which each successive frame has a greater level of noise than a preceding frame.

Determining the local time for each frame according to the first local time schedule can involve determining the local time for each frame such that, in the first local time schedule, the local time varies between the same initial time for each frame and different respective final local times for each frame. The initial time for each frame can correspond to an initial diffusion model time. The final local time for each successive frame in the training sequence can have a greater value than the final local time for the immediately preceding frame in the training sequence.

As an example, according the first local time schedule the local times can run from 1,1, . . . , 1 for each of the W frames, to

$$\frac{0}{W} , \frac{1}{W} , … , \frac{( W - 1 )}{W}$$

for the respective frames. The local time for this initialization schedule can be defined as

$${t}_{w}^{init} = clip ( \frac{w}{W} + t ) .$$

It can be seen that this includes the previous local time schedule

$$\frac{1}{W}$$

to 0 as a special case, and thus n is not essential to train using a special initialization schedule. However, this can be beneficial.

Determining the local time for each frame according the second local time schedule can involve determining the local time for each frame such that, in the second local time schedule, for frames in the training sequence the final local time for a frame corresponds to the initial local time for a preceding frame in the training sequence. That is, the second local time schedule can be as previously described.

Some implementations of the method involve selecting randomly between the first local time schedule and the second local time schedule. This can involve randomly sampling a value (β) from a distribution, e.g., a Bernoulli distribution (B(β)), and selecting between the first local time schedule and the second local time schedule according to the randomly sampled value, e.g., according to whether the value is 1 or 0.

Sampling the noisy version of a frame from the noise distribution dependent on the frame and on the local time for the frame can involve determining a mean scaling factor for the frame (α_{tw}) dependent on the local time and a variance scaling factor for the frame dependent on

$$( {σ}_{tw}^{2} )$$

dependent on the local time. The mean scaling factor and the variance scaling factor may be determined in accordance with a signal-to-noise ratio (SNR) schedule that decreases monotonically as the local time increases. For example, as previously described, the SNR may be defined

$$S N R = {α}_{tw}^{2} / {σ}_{tw}^{2} .$$

Determining one of the mean scaling factor and the variance scaling factor may determine the other, e.g., according to

$${α}_{tw}^{2} + {σ}_{tw}^{2} = 1 ,$$

which defines a variance-preserving noise (SNR) schedule.

The noisy version of the frame can be sampled from a (multivariate) Gaussian noise distribution having a mean defined by a product of the mean scaling factor and a vector representing the frame, e.g., representing values such as pixel values of the frame, and having a variance defined by the variance scaling factor.

As an example, consider a rolling window of W frames in a rolling window, each of dimensionality D, denoted by x∈ [symbol] , e.g., obtained by chunking a video into blocks of W frames. As previously, from a local time for the window t_{w}, the noise schedule can be used to determine parameters σₜ_{ₖ}, and αₜ_{ₖ}. A window of noisy frames zₜ∈ [symbol] for a time t can be determined by sampling zₜ˜q(zₜ|x) from a distribution q(zₜ|x) (re-parameterized from ϵ˜ [symbol] (0,1)) given by:

$$q ( {z}_{t} \vert x ) = {\prod }_{w = 0}^{W} 𝒩 ( {z}_{t}^{w} \vert {α}_{tw} {x}^{w} , {σ}_{tw}^{2} I )$$

In this particular example, the loss, L, can depend on a sum of ∥x−f_{θ}(zₜ, t)∥ over each frame w in the window of W frames. For example, the loss can be as determined as L=

$${\sum }_{w = 0}^{W} {‖ {x}^{w} - {f}_{θ}^{w} ( {z}_{t} , t ) ‖}^{2} or as L = {\sum }_{w = 0}^{W} a ( {t}_{w} ) {‖ {x}^{w} - {f}_{θ}^{w} ( {z}_{t} , t ) ‖}^{2}$$

where a(t_{w}) is an optional weight. As one example a(t_{w}) can define a so-called a “v-loss” (Salimans, et al., arXiv:2022.00512v2), where a(t_{w})=SNR+1. This (local to window) loss may also be denoted

$${L}_{loc , θ} ( x , t , ϵ ) = {\sum }_{w = 0}^{W} a ( {t}_{w} ) {‖ {x}^{w} - {f}_{θ}^{w} ( {z}_{t , ϵ} , t ) ‖}^{2}$$

where the dependence on the de-noising neural network parameters θ, and on ϵ (a frame of noise, e.g., sampled from a Gaussian) is made explicit.

As previously described, in some implementations the de-noising neural network can also be conditioned on one or a few previously estimated, “clean” frames. Then the loss is determined in the same way but using

$${f}_{θ}^{w} ( {z}_{t , ϵ} , {\hat{z}}_{t , ϵ}^{clean} , t )$$

instead of

$${f}_{θ}^{w} ( {z}_{t , ϵ} , t ) .$$

A particular example algorithm for training the de-noising neural network 110 in this way is given below (where, in this example, U(0,1) is a uniform distribution between 0 and 1):

```
Require: [symbol] ₜᵣ := {x₁, . . . , x_{N}}, x ∈ [symbol] ^{D×W}, n_{cln}, β, f_{θ}
repeat
  Sample x from [symbol] tr, t~U(0, 1), y~B(β)
  if y then
    $Compute local time {t}_{w}^{init} ( {n}_{cln} ) , w = 0 , … , W - 1$
  else
    $Compute local time {t}_{w}^{lin} ( {n}_{cln} ) , w = 0 , … , W - 1$
  end if
  Compute αₜ_{_{w}} and σₜ_{_{w}} for all w = 0, . . . , W − 1
  Sample zₜ~q(zₜ|x)
  Compute \hat{x} ← f_{θ}(z_{t,∈}; t)
  Update θ using L_{loc,θ} (x; t, ∈)
until Converged
```

A particular example algorithm that can be used for oversampling at a model boundary according to a Bernoulli rate, β, as described above is given below:

```
$Require : x ∈ {ℝ}^{D \times {n}_{cln}} , W , T , {t}_{w}^{init} , {p}_{θ}$
Sample z₁~ [symbol]  (0, I), z₁ ∈ [symbol] ^{D×(W -n}^{_{cln}}⁾
z₁ ← concat(x, z₁)
for t = 1, (T − 1)/T, . . . , 1/T do
  $Compute local times {t}_{w}^{init} ( {n}_{cln} ) , w = 0 , … , W - 1$
  Sample zₜ₋₁/T~p_{θ} (z_{t-1/T}|zₜ)
end for
Return z₀, which now has local times (0/W, 1/W, . . . , (W − 1)/W)
```

Implementations of the above described techniques can be used to generate any type of data. In some implementations the techniques are used for generating a video comprising a sequence of image frames, or for training a de-noising neural network for generating a video comprising a sequence of image frames. In some implementations the frames of data can represent other types of data, e.g., audio data, weather or climate data, or fluid mechanics data.

In some implementations an image frame may encode another type of data, e.g., as a spectrogram. For example, audio or other training data may be encoded as a sequence of image frames, i.e., a video sequence, and a generated video comprising a sequence of image frames may be decoded back to another type of data, i.e., that used for training the system.

As one particular example, audio or other data may be represented as a spectrogram. The audio or other data may be processed to generate a spectrogram representing the audio or other data by performing a time-frequency domain transform on an audio or other signal to generate a frequency domain representation of the audio or other signal for a range of frequencies. There are many suitable time-frequency domain transforms; as one example a short-time Fourier transform, STFT can be used. The audio or other data (signal) may be decoded from a generated spectrogram by applying the inverse of the time-frequency domain transform, i.e., a frequency-time domain transform, e.g., an inverse STFT.

In general, a spectrogram can be an image that represents the time-frequency domain transform, e.g., a representation with time on one axis, e.g., a horizontal axis, and frequency on another axis, e.g., a vertical axis. The location of a pixel of the image along the time axis can represent a time position in the audio or other data; the location along the frequency axis can represent a frequency at that time; the value of the pixel, e.g., a luminance or color value, can represent a component of the audio or other signal at that time and at that frequency, e.g., a magnitude and/or a phase of the signal. In some time-frequency domain transforms the component of the signal is represented by a complex number. Generally, the spectrogram can represent a changing spectrum of an audio or other signal over time.

Where the generated sequence of frames of data comprises a video sequence the video sequence can be, e.g., a continuation of a previous video sequence, an edited version of a video sequence, or a video sequence generated to represent a text, audio, or other conditioning input.

As another example, implementations of the system can be used to generate a video representing a predicted trajectory of a real-world physical system, such as a robot or vehicle, for use by a control algorithm in controlling the physical system. For example, a video sequence may be captured by a camera and then the system used to generate video that predicts a future state or configuration of the physical system, optionally conditioned on one or more variables relating to the physical system. The generated video can be used in a model predictive control system to control a mechanical agent such as a robot to perform a particular task, by processing the predicted image using the control system to generate control signals to control the mechanical agent, in accordance with the generated video to perform the task.

As used herein an image may be a monochrome, color or hyperspectral image, e.g., comprising monochrome, color or hyperspectral image pixels. An “image” also includes a point cloud, e.g., from a LIDAR system, and a “pixel” may then be a point of the point cloud.

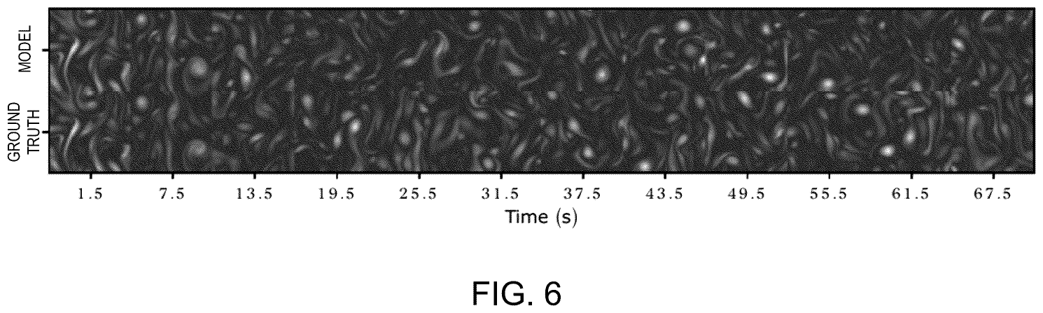

As an illustration, FIG. 6 shows a simulated Kolmogorov flow rollout, comparing frames generated by an implementation of the techniques described above (top row) with ground truth frames (bottom row). The ground truth is based on a finite volume-based direct numerical simulation of a partial differential equation that models viscous incompressible fluid flow. The ground truth structures are preserved initially, and whilst the model diverges at longer timescales the turbulent dynamics is preserved. The described techniques are able to model complex flows such as this over much longer timescales than typical simulations.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The essential elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method of obtaining a generated sequence of frames of data by successively generating frames in the sequence, the method comprising:
obtaining a sequence of frames in a rolling window of frames, the sequence of frames comprising frames in the rolling window except for a final frame, and
determining a final frame for the rolling window by sampling the final frame from a noise distribution, wherein each successive frame in the rolling window has a greater level of noise than a preceding frame in the rolling window; and
for each of a series of diffusion model time steps from an initial time step to a final time step, the initial time step and the final time step each corresponding to a respective diffusion model time:
determining a local time for each frame from the diffusion model time corresponding to the diffusion model time step, wherein the local time for a frame varies between an initial local time for the initial time step and a final local time for the final time step, and wherein the final local time for a frame corresponds to the initial local time for a preceding frame in the sequence;
obtaining an updated rolling window by, for each frame in the rolling window and for each diffusion model time step:
determining an updated version of the frame by processing the frame and the local time for the frame using a de-noising neural network to determine a reduced noise version of the frame; and
after performing the diffusion model time steps, using a first frame of the updated rolling window as a next generated frame of data of the generated sequence of frames of data, and moving the rolling window such that a second frame of the updated rolling window becomes the first frame of a next rolling window of frames.

2. The method of claim 1, wherein determining the updated version of the frame comprises:
processing the frame, the local time for the frame, and a content conditioning input using the de-noising neural network to determine the reduced noise version of the frame, wherein the content conditioning input characterizes a content of the generated sequence of frames of data.

3. The method of claim 1, comprising determining the local time for each frame such that, for each frame of the rolling window and for one or more frames preceding the rolling window, the final local time for a frame corresponds to the initial local time for a preceding frame in the sequence.

4. The method of claim 1, wherein determining the updated version of the frame comprises:
processing the frame, the local time for the frame, and a sequence conditioning input using the de-noising neural network to determine the reduced noise version of the frame, wherein the sequence conditioning input comprises one or more previously generated frames of the generated sequence of frames of data.

5. The method of claim 1, wherein determining the updated version of the frame comprises:
processing the frame and the local time for the frame using the de-noising neural network to generate a prediction of a de-noised version of the frame, and using the prediction of the de-noised version of the frame to determine the reduced noise version of the frame.

6. The method of claim 1, wherein determining the updated version of the frame comprises:
processing the frame and the local time for the frame using the de-noising neural network to generate a noise prediction comprising a prediction of noise in the frame, and using the noise prediction to determine the reduced noise version of the frame.

7. The method of claim 1, wherein determining the updated version of the frame comprises:
processing the frame and the local time for the frame using the de-noising neural network to generate a score prediction for the frame, and using the score prediction to determine the reduced noise version of the frame.

8. The method of claim 1, wherein determining the local time for each frame from the diffusion model time corresponding to the diffusion model time step comprises:
determining the local time as a monotonic function of (w+t−n_{cln})/(W−n_{cln}) where w indexes the frame in the rolling window starting from w=0 for the first frame of the rolling window, W is a total number of frames in the rolling window, and n_{cln} is an integer equal to or greater than zero.

9. The method of claim 1, further comprising determining an initial rolling window of frames by:
sampling each frame in the initial rolling window of frames from a noise distribution;
for each of a series of diffusion model time steps determining a local time for each frame in the initial rolling window of frames from the diffusion model time corresponding to the diffusion model time step; and
obtaining the initial rolling window of frames by, for each frame in the initial rolling window of frames and for each diffusion model time step:
determining an updated version of the frame by processing the frame and the local time for the frame using the de-noising neural network, to determine a reduced noise version of the frame.

10. A computer-implemented method of training a de-noising neural network for use in a system to generate a sequence of frames of data, comprising:
obtaining a training dataset comprising training sequences, each training sequence comprising a sequence of frames of data and, for each of a plurality of the training sequences:
sampling a diffusion model time from a distribution of diffusion model times;
determining a local time for each frame of the training sequence from the diffusion model time; and
for each frame of the training sequence:
sampling a noisy version of the frame from a noise distribution dependent on the frame and on the local time for the frame;
processing the noisy version of the frame and the local time for the frame using the de-noising neural network to determine an estimate of the frame;
training the de-noising neural network using an objective function that depends on a difference between the frame and the estimate of the frame.

11. The method of claim 10, wherein determining the local time for each frame of the training sequence comprises selecting between:
a first local time schedule for training the de-noising neural network to initialize a sequence of generated video frames such that each successive frame has a greater level of noise than a preceding frame, and
a second local time schedule for training the de-noising neural network to determine a reduced noise version of each frame in a sequence of frames in which each successive frame has a greater level of noise than a preceding frame.

12. The method of claim 11, wherein determining the local time for each frame according the first local time schedule comprises:
determining the local time for each frame such that, in the first local time schedule, the local time varies between the same initial time for each frame and different respective final local times for each frame, the initial time for each frame corresponding to an initial diffusion model time, the final local time for each successive frame in the training sequence having a greater value than the final local time for the immediately preceding frame in the training sequence.

13. The method of claim 11, wherein determining the local time for each frame according the second local time schedule comprises:
determining the local time for each frame such that, in the second local time schedule, for frames in the training sequence the final local time for a frame corresponds to the initial local time for a preceding frame in the training sequence.

14. The method of claim 11, comprising selecting randomly between the first local time schedule and the second local time schedule.

15. The method of claim 10, wherein, for each frame of the training sequence, sampling the noisy version of the frame from the noise distribution dependent on the frame and on the local time for the frame comprises:
determining a mean scaling factor for the frame dependent on the local time and a variance scaling factor for the frame dependent on the local time, wherein the mean scaling factor and the variance scaling factor are determined in accordance with a signal-to-noise ratio schedule that decreases monotonically as the local time increases; and
sampling the noisy version of the frame from a Gaussian noise distribution having a mean defined by a product of the mean scaling factor and a vector representing the frame and having a variance defined by the variance scaling factor.

16. The method of claim 10, wherein processing the noisy version of the frame and the local time for the frame using the de-noising neural network to determine the estimate of the frame comprises either:
I) processing the frame and the local time for the frame using the de-noising neural network to generate a prediction of a de-noised version of the frame, and using the prediction of the de-noised version of the frame to determine the estimate of the frame; or
ii) processing the frame and the local time for the frame using the de-noising neural network to generate a noise prediction comprising a prediction of noise in the frame, and using the noise prediction to determine the estimate of the frame; or
iii) processing the frame and the local time for the frame using the de-noising neural network to generate a score prediction for the frame, and using the score prediction to determine the estimate of the frame.

17. The method of claim 1, wherein the frames of data comprise image frames of a video sequence.

18. The method of claim 17, for generating a video comprising a sequence of image frames, or for training a de-noising neural network for generating a video comprising a sequence of image frames, wherein the video sequence is either i) a continuation of a previous video sequence, ii) an edited version of a video sequence, or iii) a video sequence generated to represent a text or audio conditioning input.

19. A system comprising one or more computers and one or more storage devices communicatively coupled to the one or more computers, wherein the one or more storage devices store instructions that, when executed by the one or more computers, cause the one or more computers to perform operations for obtaining a generated sequence of frames of data by successively generating frames in the sequence, the operations comprising:
obtaining a sequence of frames in a rolling window of frames, the sequence of frames comprising frames in the rolling window except for a final frame, and
determining a final frame for the rolling window by sampling the final frame from a noise distribution, wherein each successive frame in the rolling window has a greater level of noise than a preceding frame in the rolling window; and
for each of a series of diffusion model time steps from an initial time step to a final time step, the initial time step and the final time step each corresponding to a respective diffusion model time:
determining a local time for each frame from the diffusion model time corresponding to the diffusion model time step, wherein the local time for a frame varies between an initial local time for the initial time step and a final local time for the final time step, and wherein the final local time for a frame corresponds to the initial local time for a preceding frame in the sequence;
obtaining an updated rolling window by, for each frame in the rolling window and for each diffusion model time step:
determining an updated version of the frame by processing the frame and the local time for the frame using a de-noising neural network to determine a reduced noise version of the frame; and
after performing the diffusion model time steps, using a first frame of the updated rolling window as a next generated frame of data of the generated sequence of frames of data, and moving the rolling window such that a second frame of the updated rolling window becomes the first frame of a next rolling window of frames.
